(19) United States
(12) Patent Application Publication
(10) Pub. No.: US 2009/0267944 A1
(43) Pub. Date: Oct. 29, 2009

(54) METHOD FOR DISPLAY OF DIGITAL IMAGES

(76) Inventors: Thomas J. Bouchard, Vienna, VA (US); Gaylord Delancey Wetherill, III, Mission Hills, KS (US); William R. Bouchard, Cambridge, MA (US)

Correspondence Address: ERICKSON, KERNELL, DERUSSEAU & KLEYPAS, LLC, 800 W. 47TH STREET, SUITE 401, KANSAS CITY, MO, 64112, US

(21) Appl. No.: 12/431,463

(22) Filed: Apr. 28, 2009

Related U.S. Application Data
(60) Provisional application No. 61/125,739, filed on Apr. 28, 2008.

(51) Int. Cl. G06T 17/00; G09G 5/00

(52) U.S. Cl. 345/428; 345/620; 345/660

(57) ABSTRACT

A method of displaying and manipulating a digital image is presented. The system extracts information from an image and from the display and display drivers to determine presentation parameters. The user may select various functions to present the image in a desired manner.

### CROSS-REFERENCE TO RELATED APPLICATION

This application claims priority to provisional application Ser. No. 61/125,739, filed Apr. 28, 2008.

### BACKGROUND

The present invention relates generally to digital image manipulation and, more particularly, to a method for displaying a digital image or portions thereof according to the monitor resolution and stored image resolution.

The ability to enlarge or shrink a digital image is known in the art. Various software products are available that allow the user to zoom into/out of a digital image by enlarging or shrinking the image. These programs may take the image loaded and enlarge an area by spreading an image pixel over two or more display pixels to zoom into the image. Likewise, the program may zoom out of an image by dropping or not displaying a proportional number of image pixels for a particular desired display size. These programs, although allowing the user to zoom into and out of an image, do not display the image at the optimal resolution for the particular display, or not all of the available information is displayed thus providing poor or less than satisfactory results.

### SUMMARY

The present invention provides a method for displaying a digital image at a resolution selected by the user. Enlargement of the image is accomplished by extracting additional information from the high quality image and sized to match the monitor resolution. The method may be applied to any digital image regardless of the source or display software.

### BRIEF DESCRIPTION OF THE DRAWINGS

FIG. 1 is an illustration of an image source for manipulation by the present method.

FIG. 2 is a diagram of an image divided into areas.

FIG. 3 is a flow chart depicting the method of the present invention.

### DETAILED DESCRIPTION

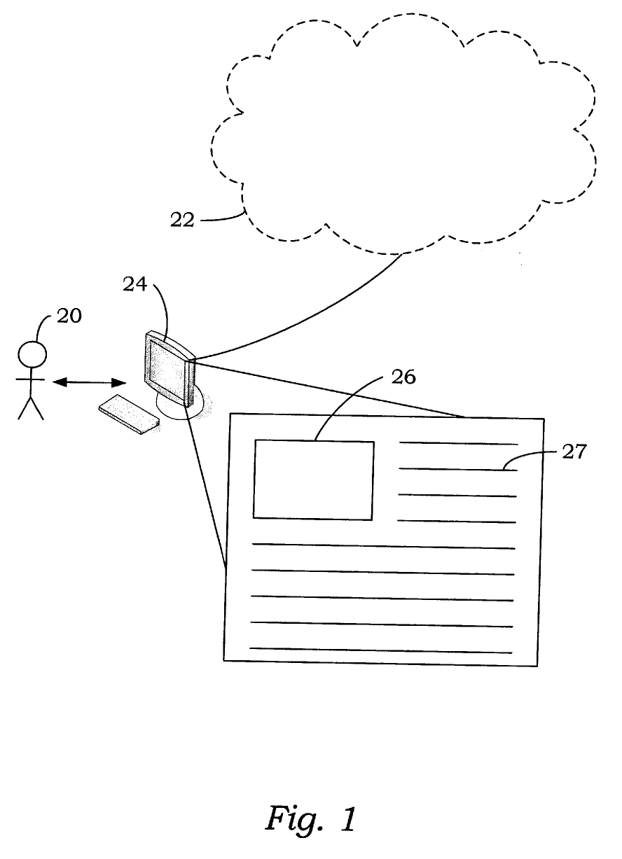

Referring initially to FIG. 1, a user may access the internet or worldwide web 22 using a personal computer 23, for example. Content from the internet is displayed on the user's monitor 24. Images 26 may be shown as icons, links or thumbnails, along with text 27. The thumbnail image may be enlarged by selecting the thumbnail.

When the image 26 is initially accessed, all information about the image is gathered by the system. This information may include size, color depth and pixels, for example. Additionally, all information related to the capabilities of the monitor 24 and video drivers are also gathered by the system.

The image resolution describes the information or detail that an image holds. Typically, for digital images, resolution is specified as a number of pixels, which can be specified as two numbers such as 640 by 480, or by a single number such as 3.1 megapixels, which is the total number of pixels. When two numbers are given, the first refers to the number of pixel columns (width of the image) and the second refers to the number of pixel rows (height of the image). The total number of pixels can be calculated from the two numbers by multiplying the pixel columns by the pixel rows. Sometimes image resolution is described as pixels per length unit or pixels per area unit, such as pixels per inch or per square inch.

Generally, a pixel is the smallest single component of an image, which is displayed as a dot or square. In an LCD display, each pixel is a physical triad. When the monitor's resolution matches that of the image's resolution, it is referred to as a native resolution. Images will be displayed best when the image resolution is greater than or matches the native resolution. If the image resolution is less than the monitor resolution, the image may appear blurry.

Other information describing a pixel is the number of distinct colors that can be represented by the pixel, which is the number of bits per pixel (bpp) or color depth. The maximum number of distinct colors that a pixel can represent can be determined by taking two to the power of the color depth. For example, a color depth of 24 is 2²⁴ colors or 16,777,216 colors, which is also known as Truecolor. A 24-bit depth allows 8 bits per RGB (red, green, and blue) component.

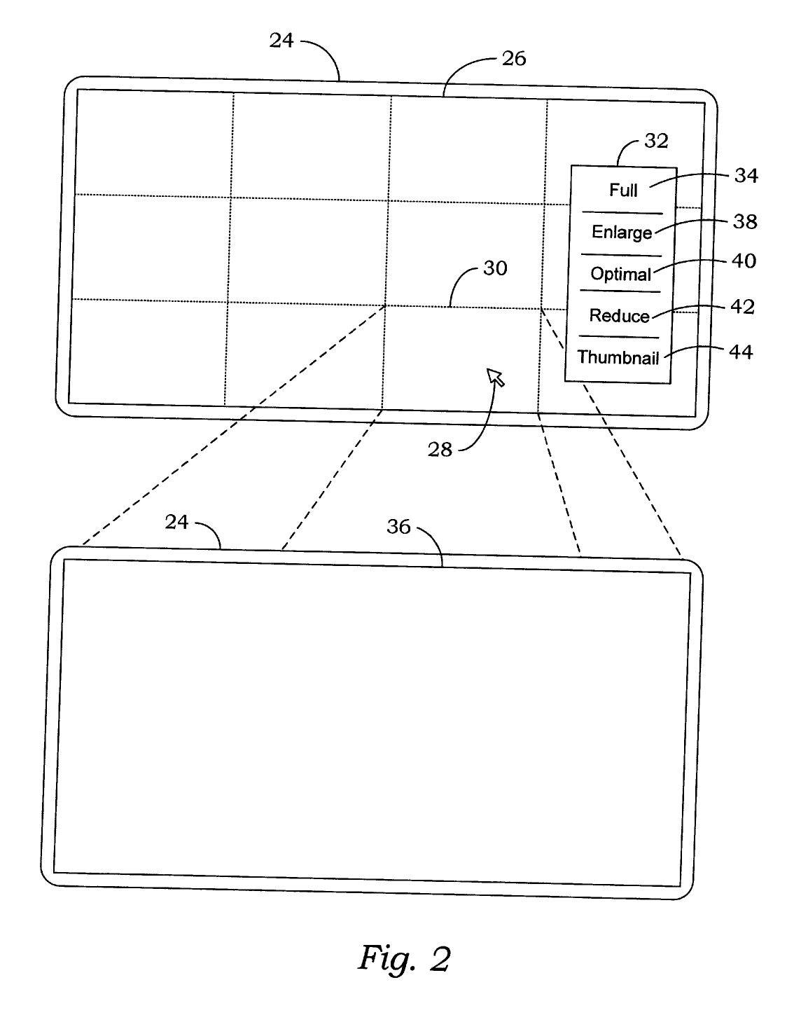

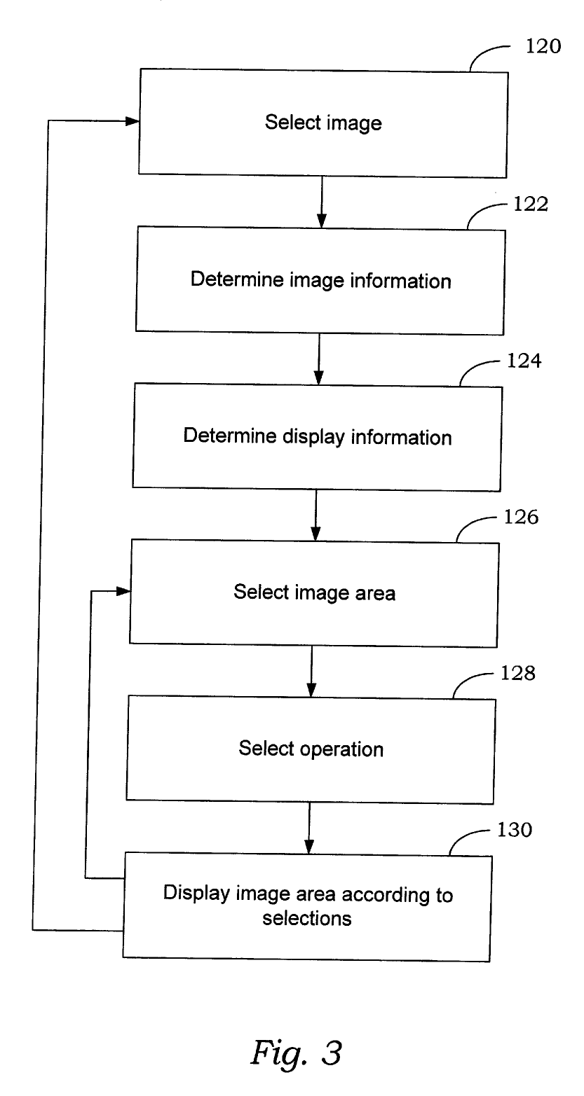

Referring to FIGS. 2 and 3, an image 26 is selected 120 to be displayed at a resolution consistent with the capabilities of the monitor 24 and the image. The image information is gathered 122 along with the display information 124. For example, the image 26 may be 3000 pixels by 2000 pixels as stored on the web-based server. When viewed on a monitor 24 with a resolution or setting of 800 pixels by 600 pixels, approximately every 12th image pixel is displayed even though additional information (i.e., resolution) is available for display.

The image 26 may be divided into twelve areas on monitor 24. It should be understood that any number of areas may be used and that the twelve areas are for illustrative purposes only. The user may select any area for enlargement 126 by moving a cursor 28 or other pointing device over the desired area 30 and right-clicking or otherwise selecting the area. A menu 32 may be displayed which provides the user with available enlargement and reduction choices 128.

For example, the user may select “Full” 34 for area 30. The selected area 30 of the image 26 is resized 130 to display a 800 pixel by 600 pixel image 36. The image 36 is approximately 500,000 pixels so it is displayed at the full resolution of the display without any distortion.

If “Enlarge” 38 is selected, the selected area 30 is enlarged incrementally until the optimal image display is reached. Any further enlargement of the image will result in a single pixel from the image being displayed as two or more monitor 24 pixels.

If “Optimal” 40 is selected, the selected area 30 is displayed in the native resolution matching the display resolution with the image resolution pixel for pixel.

If “Reduce” 42 is selected, the selected area 30 is reduced incrementally until it is displayed as a thumbnail image. If “Thumbnail” 44 is selected, the selected area 30 is reduced to a thumbnail image.

The enlargement/reduction function may be implemented as a separate program that is used to view digital images or more preferably as a plug-in to Internet Explorer, Mozilla FireFox or other internet browser.

Accordingly, it should be understood that while certain forms of the invention have been illustrated and described, it is not limited thereto except insofar as such limitations are included in the following claims.

Having thus described the invention, what is claimed as new and desired to be secured by Letters Patent is as follows:

1. A method of displaying a digital image comprising:
selecting a digital image for presentation on a display,
determining information from said digital image,
determining information from said display,
selecting an area of said digital image for presentation on said display,
selecting an operation to manipulate said digital image, and
presenting said digital image in accordance with said selected operation.

2. The method of claim 1 wherein said digital image is a thumbnail image, and wherein said information from said digital image includes size of a native resolution for said image.

3. The method of claim 1 said information from said digital image includes size, color depth and/or pixels.

4. The method of claim 1 wherein said information from said display includes resolution of said display.

5. The method of claim 1 wherein said information from said display includes resolution of video drivers to control said display.

6. The method of claim 1 wherein said information from said display includes a native resolution for said display.

7. The method of claim 1 wherein said selecting an area includes a portion of a total area of said display.

8. The method of claim 1 wherein said selecting an operation includes selecting full, enlarge, optimal, reduce or thumbnail.

9. The method of claim 8 wherein said full operation includes resizing said selected area to be presented on said display at the full size of said display.

10. The method of claim 8 wherein said enlarge operation includes enlarging said selected area incrementally until an optimal image is presented on said display.

11. The method of claim 8 wherein said optimal operation includes resizing said selected area to be presented on said display at the native resolution of said display.

12. The method of claim 8 wherein said reduce operation includes reducing said selected area incrementally until a thumbnail image is presented on said display.

13. The method of claim 8 wherein said thumbnail operation includes reducing said selected area until a thumbnail image is presented on said display.

14. The method of claim 8 wherein said reduce operation includes reducing said selected area until a thumbnail image is presented on said display.

15. The method of claim 1 wherein said last three steps are repeated.

16. The method of claim 1 wherein said steps are repeated.

17. The method of claim 1 wherein said method is executed on a web-based server.

18. The method of claim 1 wherein said method is executed on a personal computer.

19. The method of claim 1 wherein said method is executed on a hand-held device having a display.
